(19) United States
(12) Patent Application Publication
(10) Pub. No.: US 2003/0080686 A1
(43) Pub. Date: May 1, 2003

(54) Light controller and system for sensitivity control

(75) Inventor: Mervin A. Dayan, Oakhurst, NJ (US)

Correspondence Address: Robert F. Zielinski, Wolf, Block, Schorr and Solis-Cohen LLP, 1650 Arch Street, 22nd Floor, Philadelphia, PA, 19103-2097, US

(73) Assignee: Roadmaster (USA) Corp., Eatontown, NJ

(21) Appl. No.: 10/107,034

(22) Filed: Mar. 27, 2002

Related U.S. Application Data
(63) Continuation-in-part of application No. 09/999,153, filed on Oct. 30, 2001.

(51) Int. Cl. B60Q 1/02

(52) U.S. Cl. 315/129; 315/131; 315/134

(57) ABSTRACT

A light control device and method are provided for receiving an audible signal from an audio speaker and outputting a light control signal, whereby the light control signal controls the illumination of a light source placed near the audio speaker.

### CROSS REFERENCE TO RELATED APPLICATIONS

The present application is a continuation-in-part of U.S. patent application Ser. No. 09/999,153, entitled LIGHT CONTROLLER WITH SENSITIVITY CONTROL, filed Oct. 30, 2001, the entire disclosure of which is hereby incorporated by reference.

### BACKGROUND OF THE INVENTION

Audio or stereo systems are often used to provide audible entertainment. The audible signal from the stereo system may derive from a variety of sources, such as CDs, tapes, DVDs, MP3 recordings, vinyl records and/or radio stations. Audiophiles (i.e., people with passionate interests in stereo or high fidelity sound reproduction) and others who enjoy stereo systems are always seeking ways to enhance the quality of their listening experience.

One way to provide such enhancement is to add a visual aspect to aural perception. For instance, speakers of a stereo system may be provided with a light source, such as a neon light, to provide visual effects in conjunction with the audible sound. Such visual enhancement can be used to reflect the personal tastes of a listener, much as customizing a car by employing components such as spoilers, chrome wheel covers and tinted windows express the car owner's personality.

In one example of using light to enhance the listening experience, car stereo speakers may be fitted with a light source placed near the speaker. In particular, a neon light may be fitted around the perimeter of the speaker. In the past, neon lights may have been employed to light whenever the stereo was on. Or, the lights may have been programmed to turn on and off in a predetermined manner. Also, the lights may have been connected between an audio source and the speaker so as to turn on in direct response to the audio source. For example, a light source may have been electrically connected to a ground wire of the speaker such that the light was turned on at the same time the speaker was activated by the audio source. However, these alternatives provide little control, if any, to the user who may wish to adjust the operation of the light in response to the music or her mood.

### SUMMARY OF THE INVENTION

The present invention provides a light controller and system with sensitivity control that allows a user to fully customize light operation.

In accordance with one aspect of the present invention, a light control device is provided for controlling a visual display of a light source. The light control device includes an audio input and a light control unit. The audio input is for receiving an audible signal produced remotely. The audio input sends an output signal based upon the audible signal. The light control unit receives the output signal and sends a light control signal to adjustably control the light source. The light control device preferably includes a sensitivity adjuster that is operable to receive the output signal and form an adjusted signal for output to the light controller unit.

In accordance with another aspect of the present invention, a light control device is provided. The light control device includes an audio input, a light controller unit, and a sensitivity adjuster. The audio input receives an audible signal and sends an output signal based upon the audible signal. The light controller unit receives the output signal and sends a light control signal to adjustably control a light source. The sensitivity adjuster is operable to adjust the light control signal whereby the light source is variable between a minimum and a maximum brightness. Preferably, the sensitivity adjuster comprises a potentiometer.

In accordance with yet another aspect of the present invention, an apparatus is provided comprising an audio input, a sensitivity adjuster, a light controller unit and a speaker unit. The audio input is for receiving an audible signal produced remotely and sending an output signal based upon the audible signal. The sensitivity adjuster is operable to receive the output signal and send an adjusted signal. The light controller unit is for receiving the adjusted signal and sending a light control signal to adjustably control a light source. The speaker unit includes a housing and a speaker disposed in the housing. The light source is disposed adjacent to the housing. Preferably, the housing includes a speaker input to drive the speaker and a light control input in proximity to the speaker input, whereby the light control input is connected to the light source and is operable to receive the light control signal and pass the light control signal to the light source. Preferably, the light source is a neon light.

In accordance with another aspect of the present invention, a method of controlling at least one light source is provided. An audible signal produced remotely is received. A sensitivity-adjusted signal is formed based upon the audible signal. The sensitivity-adjusted signal is operable to adjust a brightness of the at least one light source. A light control signal formed in relation to the sensitivity-adjusted signal and is output, whereby the at least one light source is controlled in response to the light control signal. Preferably, the method includes selecting a mode of operation from one of several modes. A first mode may be selected in which the light control signal is operable to turn the light source on continuously. A second mode may be selected in which the light control signal is operable to turn the light source off. A third mode may be selected in which the light control signal is operable to turn the light source on and off in response to the audible signal.

In accordance with yet another aspect of the present invention, a light control device is provided. The light control device comprises an audio input, a light controller unit, a sensitivity adjuster, a power indicator, and a connector. The audio input is for receiving an audible signal and producing an output signal based upon the audible signal. The light controller unit is for receiving the output signal and forming a light control signal to adjustably control a light source. The light controller unit has selectable operational modes. A first mode is selectable in which the light control signal is operable to turn the light source on continuously. A second mode is selectable in which the light control signal is operable to turn the light source off. A third mode is selectable in which the light control signal is operable to turn the light source on and off in response to the audible signal. The sensitivity adjuster is operable to adjust the light source between a minimum and a maximum brightness. The power indicator indicates whether the light control device is on. The connector is operable to supply power to the light source. Preferably, the light controller unit includes a transformer operable to modify the light control signal before the light control signal is supplied to the light source.

In accordance with another aspect of the present invention, a speaker housing is provided. The speaker housing comprises a cabinet, a connection disposed on the cabinet, and an input adjacent to the connection. The connection is operable to receive an audible signal and provide the audible signal to a speaker. The input is operable to receive a light control signal and provide the light control signal to a light source. Preferably, the connection and the input are disposed on a back face of the cabinet.

In accordance with yet another aspect of the present invention, a speaker housing is provided, wherein the speaker housing comprises a cabinet, a speaker disposed in the cabinet, a light source disposed adjacent to the speaker, a connection operable to receive an audible signal and provide the audible signal to the speaker, the connection being disposed in the cabinet remote from the speaker, and an input adjacent to the connection, the input being operable to receive a light control signal and provide the light control signal to the light source.

In accordance with yet another aspect of the present invention, a terminal block is provided. The terminal block comprises a base unit, a connection and an input. The connection is disposed on the base unit, and is operable to receive an audible signal and provide the audible signal to a speaker. The input is operable to receive a light control signal and provide the light control signal to a light source. Preferably, the terminal block has a rectangular or circular shape. Preferably, the connection includes a terminal. The terminal has a receptacle and a pushbutton. The receptacle is operable to receive a speaker wire. The push button is operable to permit insertion and prevent accidental removal of one speaker wire from the receptacle.

The foregoing aspects of the present invention will be further appreciated when considered with reference to the following description of the preferred embodiments and accompanying drawings.

### BRIEF DESCRIPTION OF THE DRAWINGS

FIG. 1 is a block diagram of a light controller according to a preferred embodiment of the present invention having several customization options and a single speaker output.

FIG. 2 is an illustration of a speaker unit including a neon light controllable according to the light controller of FIG. 1.

FIG. 3 is a block diagram of a light controller according to another preferred embodiment of the present invention including multiple customization options and a dual speaker output.

FIG. 3A is a block diagram of a light controller according to yet another preferred embodiment of the present invention including a dual speaker output.

FIG. 4 is a front perspective view of a speaker cabinet including a pair of stereo speakers and neon lights operable to be controlled by the light controller of FIG. 3.

FIG. 5 is a rear perspective view of the speaker cabinet of FIG. 4.

FIG. 5A is an illustration of a terminal block.

FIG. 6 is an interior view of the speaker cabinet of FIG. 4.

FIG. 7 is a schematic diagram illustrating electrical connectivity inside the speaker cabinet of FIG. 4.

FIG. 8 is a schematic diagram illustrating a circuitry example for the controller of FIG. 1.

FIG. 9 is a schematic diagram illustrating a circuitry example for the controller of FIG. 3.

### DETAILED DESCRIPTION

The present invention allows a user to control a light source in relation to an audible signal. For example, a user can control the display of one or more light sources to create visual effects in relation to the beat of the music playing on a stereo system. Generally, the light controller receives an audible signal output from a speaker, one or more light-controlling alternatives are set or adjusted according to the user's preferences, and the light controller outputs a light controlling signal which drives a light source proximate to the speaker based upon the light-controlling alternatives.

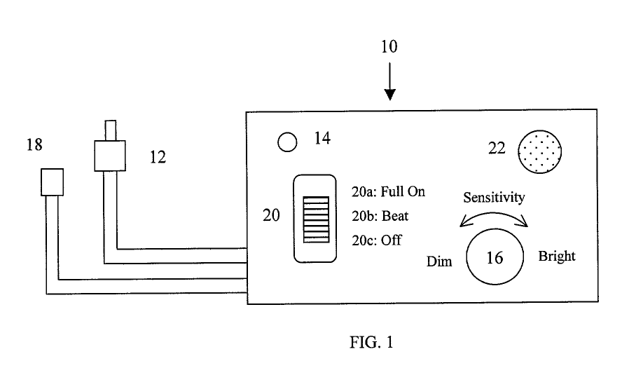

The specific features of the present invention will now be discussed in relation to the figures. FIG. 1 is a block diagram of a controller 10 according to a preferred embodiment of the invention for controlling a single light source. Controller 10 includes connectors 12 and 18, a power indicator 14, a sensitivity adjuster 16, a controller switch 20, and an audio input 22.

Controller 10 may be powered through connector 12. If the controller 10 is used to control a light source in, for example, a car, then the connector 12 is preferably a car cigarette adaptor plug. Alternatively, the connector 12 can be adapted to be wired directly into the car's electrical system. If the controller 10 is used to control a light source in conjunction with a home stereo system, then connector 12 is preferably a standard two-prong adaptor that fits into a conventional wall outlet. Other power connector types will be evident to those skilled in the art. Alternatively, the controller 10 may be battery powered for more portable use.

The connector 18 preferably controls the light source. Connector 18 can be a standard audio jack or plug, or other connection. The connector 18 may include direct wiring between the controller 10 and the light source. In an alternative embodiment, the controller 10 may connect to the light source using wireless connection means. For instance, the controller 10 may connect to the light source through a radio frequency or infrared signal.

Power indicator 14 may comprise a light emitting diode or other visual indicator that illuminates to show that the controller 10 is operating when power is supplied.

The controller switch 20 of controller 10 may provide the user with various modes of operation. Preferably, controller switch 20 provides light-controlling alternatives. In FIG. 1, three options are shown. When the user selects a “Full On” option 20a, the light source preferably is always turned on when controller 10 is on. When the user chooses an “Off” option 20c, the light source preferably is not illuminated in response to the audible signal. When the user selects a “Beat” 20b, then the light source preferably flashes, beats or changes visually in response to the audible signal. Different visual effects of the light source are possible, including, but not limited to flashing or pulsing on and off, dimming and brightening, and changing color.

The controller 10 preferably includes the audio input 22 to receive audible information such as audible music signals generated from one or more speakers. The audio input 22 may be a transducer or microphone, for example.

Controller 10 preferably includes the sensitivity adjuster 16. The sensitivity adjuster 16 preferably provides additional light-controlling alternatives. The sensitivity adjuster 16 is preferably operable to adjust a light control signal produced by the controller 10, whereby the brightness of the light source is adjusted. Preferably, the sensitivity adjuster 16 comprises an adjustable transformer or potentiometer.

In one embodiment, the sensitivity adjuster 16 can be substantially adjusted between a minimum and a maximum volume. When the sensitivity adjuster 16 is set to a substantially maximum volume, the light control signal preferably causes the light source to illuminate during the receipt of an audible signal by controller 10. When the sensitivity adjuster 16 is set to a substantially minimum volume, the light control signal preferably causes the light source to not illuminate at all, or alternatively, may cause the light source to illuminate only in response to a very strong audible signal received by the controller 10. Selecting a sensitivity between the maximum and the minimum volume preferably has an intermediate effect, such as causing the light source to illuminate only in response to an audible signal of intermediate strength. The sensitivity adjuster 16 preferably adjusts by means of an adjustable transformer or potentiometer. The audible signal may be within the range of human hearing, or may be below or above the range of human hearing. As a first example, the audible signal may include very low frequencies, such as 20 Hz, whereby the beat of the audible signal can be felt by actuation of a subwoofer, but cannot be heard by the human ear. As a second example, the audible signal may include very high frequencies, such as 25 KHz, which also cannot be heard. Therefore, in accordance with an aspect of the invention, it is possible for the light source to illuminate even when the audible signal is beyond the range of human hearing.

In another embodiment of the invention, the sensitivity adjuster 16 may adjust a light control signal so that the light source has a brightness substantially between a minimum brightness (e.g., “dim”) and a maximum brightness (e.g., “bright”). Preferably, the sensitivity adjuster 16 comprises an adjustable transformer or potentiometer to control the light control signal by, for example, varying the voltage of the light control signal. For example, when the sensitivity adjuster 16 is set to a maximum setting, then the light control signal preferably causes the light source to have a substantially maximum illumination when it turns on (which may be on all the time or on in response to the beat of the audible signal, as described above). When the sensitivity adjuster 16 is set to a minimum setting, then the light control signal preferably causes the light source to have a substantially minimal (or no) illumination when it turns on. Selecting a setting between the maximum and minimum preferably has an intermediate effect, such as causing the light source to light up at an intermediate illumination level.

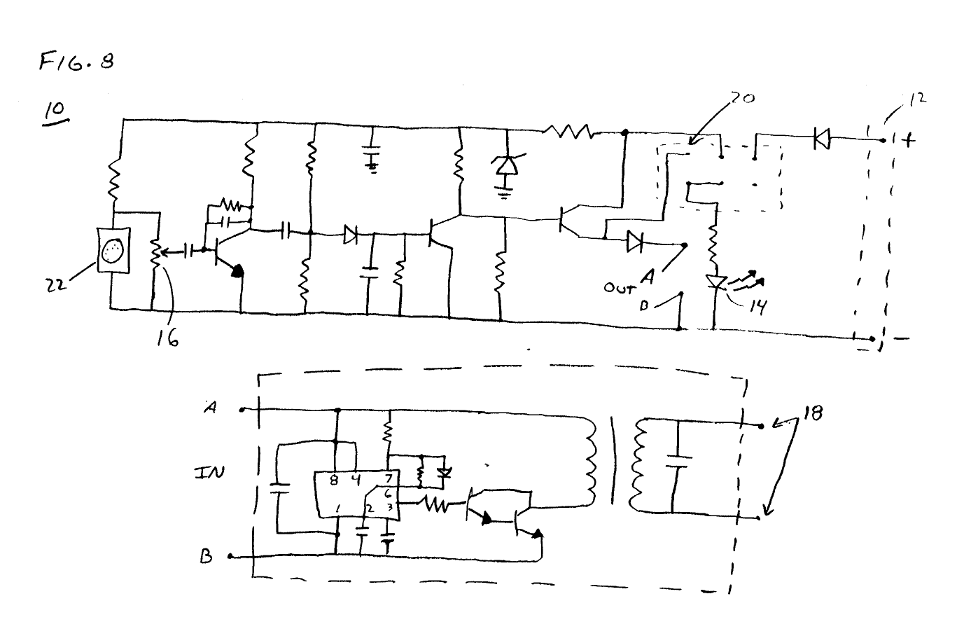

The specific circuitry for implementing the various embodiments of the controller 10 will be apparent to those skilled in the electrical arts from the description of the invention herein. One example of such circuitry for implementing the controller 10 is shown in the schematic diagram 80 of FIG. 8. Specifically, the schematic diagram of FIG. 8 illustrates that the audio input 22 is electrically connected to the sensitivity adjuster 16. The power indicator 14 is preferably a light emitting diode. The switch 20 preferably permits a user to switch between the modes 20a, 20b and 20c described earlier in relation to FIG. 1. The connector 18 preferably outputs the light control signal to the light. The connector 12 is preferably supplied by a 12-volt DC input and powers the controller 10. The controller 10 optionally includes a timing circuit 82 for processing a signal before it is supplied to a light source. The timing circuit 82 preferably supports one or more modes of operation to rectify, time lapse magnify, or otherwise modulate a signal in controller 10. An example of such a timing circuit is the NE555 Precision Timer produced by Texas Instruments. The controller 10 preferably includes a transformer 84 connected to the connector 18, wherein the transformer 84 may translate a DC input preferably received from connector 12 into an AC signal that is preferably supplied to the light source by the connector 18.

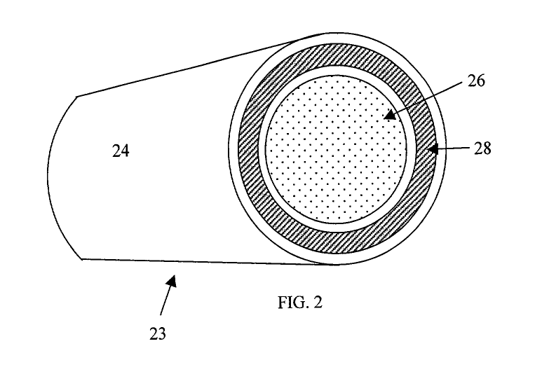

FIG. 2 illustrates a speaker unit 23 integrated with a light that may be operated by a controller according to the embodiment of FIG. 1. The speaker unit 23 includes a case 24, a grill cover 26 and a light 28. Within the case 24 is a speaker (not shown).

The grill cover 26 covers the front of the speaker unit 22. One purpose of the grill cover 26 may be to protect the speaker. Another purpose of the grill cover 26 may be to provide a visually pleasing appearance. The grill cover 26 can be formed from one or more of a variety of materials, such as wire mesh, cloth, or other materials that allow audible sound to pass from the speaker unit 23 to a listener. The grill cover 26 may be provided in any desired color or shape.

Surrounding the grill cover 26 is the light 28. Preferably, the light 28 employs neon technology. The light 28 may be connected to the controller 10 (FIG. 1) such that it illuminates according to control options set by the user. The light 28 may be formed in many different shapes and sizes. While the light 28 shown in FIG. 2. is disposed about the grill cover 26, the light 28 does not have to be adjacent to the speaker unit 22 or about the grill cover 26. Indeed, the light 28 may be placed apart (e.g., remote) from the speaker unit 22 depending upon the effect desired by the user.

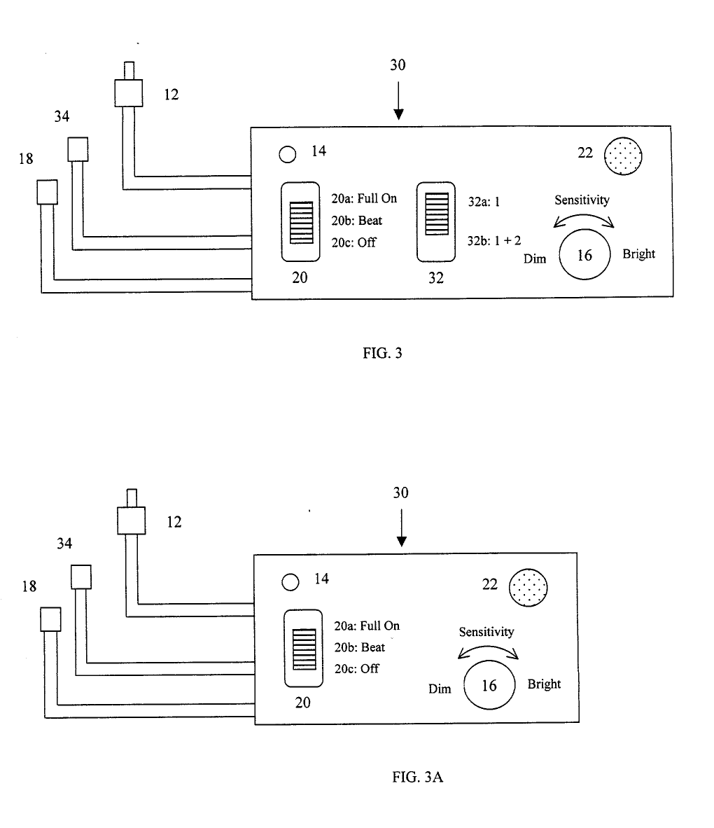

FIG. 3 illustrates a controller 30 according to another preferred embodiment of the invention. The controller 30 is similar to the controller 10 of FIG. 1. However, the controller 30 is operable to control multiple light sources, and preferably includes connectors 12, 18 and 34, a power indicator 14, a sensitivity adjuster 16, a controller switch 20, an audible input 22, and a switch 32.

The controller 30 is preferably powered through the connector 12. If the controller 30 is used to control a light source in, for example, a car, then the connector 12 is preferably a car cigarette adaptor plug. Alternatively, the connector 12 can be adapted to be wired directly into the car's electrical system. If the controller 30 is used to control a light source in conjunction with a home stereo system, then the connector 12 is preferably a standard two-prong adaptor that fits into a conventional wall outlet. Other power connector types will be evident to those skilled in the art. Alternatively, the controller 30 may be battery powered for more portable use.

The power indicator 14 may comprise a light emitting diode or other visual indicator that illuminates to show that the controller 30 is operating when power is supplied.

The controller switch 20 of the controller 30 provides the user with various modes of operation. Preferably, the controller switch 20 provides light-controlling alternatives. In FIG. 3, three options are shown. When the user selects a “Full On” option 20a, the light source (not shown) preferably is always turned on when controller 30 is on. When the user chooses an “Off” option 20c, the light source preferably will not be illuminated in response to the audible signal. When the user selects a “Beat” 20b, then the light source preferably flashes, beats or changes visually in response to the audible signal. Different visual effects are possible, including, but not limited to flashing or pulsing on and off, dimming and brightening, and changing color.

The controller 30 preferably includes the audio input 22 to receive audible information such as audible music signals generated from one or more speakers. The audio input 22 may be a transducer or microphone, for example.

Preferably, the controller 30 includes the sensitivity adjuster 16. The sensitivity adjuster 16 preferably provides additional light-controlling alternatives. The sensitivity adjuster 16 is preferably operable to adjust a light control signal produced by the controller 30, whereby the brightness of the light source is adjusted. Preferably, the sensitivity adjuster 16 includes an adjustable transformer or potentiometer.

In one embodiment, the sensitivity adjuster 16 can be substantially adjusted between a minimum and a maximum volume. When the sensitivity adjuster 16 is set to a substantially maximum volume, the light control signal preferably causes the light sources to illuminate during the receipt of an audible signal by controller 30. When the sensitivity adjuster 16 is set to a substantially minimum volume, the light control signal preferably causes the light sources to not illuminate at all, or alternatively, may cause the light sources to illuminate only in response to a very strong audible signal received by the controller 30. Selecting a sensitivity between the maximum and the minimum volume preferably has an intermediate effect, such as causing the light source to illuminate only in response to an audible signal of intermediate strength. The sensitivity adjuster 16 preferably adjusts by means of an adjustable transformer or potentiometer.

In another embodiment, the sensitivity adjuster 16 may adjust a light control signal so that the light source has a brightness substantially between a minimum brightness (e.g., “dim”) and a maximum brightness (e.g., “bright”). Preferably, the sensitivity adjuster 16 comprises an adjustable transformer or potentiometer to control the light control signal by, for example, varying the voltage of the light control signal. For example, when the sensitivity adjuster 16 is set to the substantially maximum brightness, then the light control signal will preferably cause the light source to have a substantially maximum illumination when it turns on (which may be on all the time or on in response to the beat of the audible signal, as described above). When the sensitivity adjuster 16 is set to the substantially minimum brightness, then the light control signal preferably causes the light source to have minimal (or no) illumination when it turns on. Selecting a sensitivity between the substantially maximum and minimum brightness preferably has an intermediate effect, such as causing the light source to light up at an intermediate illumination level.

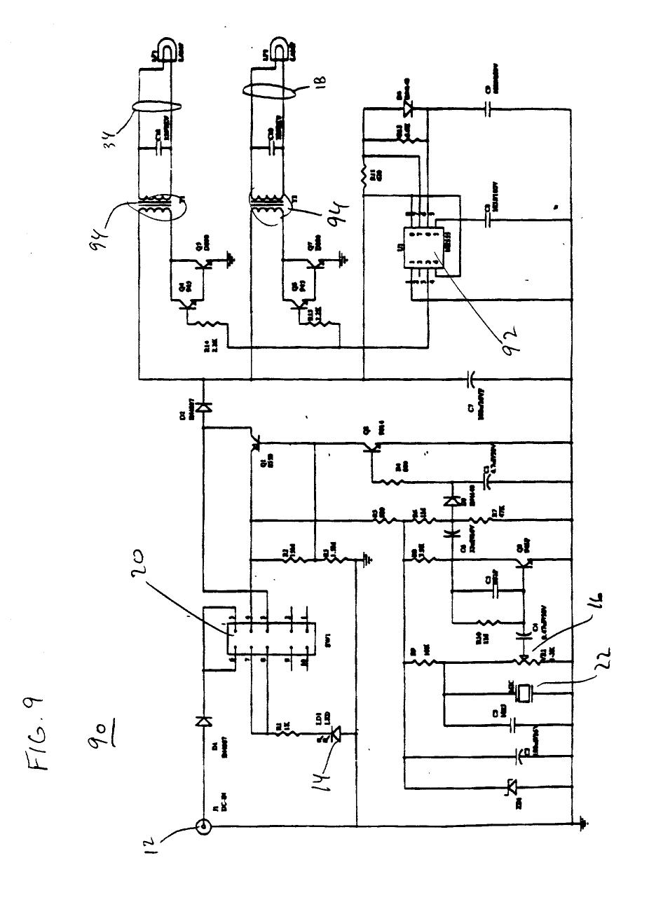

The controller 30 optionally includes the switch 32, which may be adjusted to operate one or more light sources. In one embodiment of the invention, the switch 32 operates one or two light sources. For example, when the switch 32 is set to the “1” position 32a, a first light is preferably powered through the connector 18. When the switch 32 is set to the “1+2” position 32b, a first light is preferably powered through the connector 18 and a second light is preferably powered through the connector 34. Alternative embodiments are possible, such as selecting light 1 or 2, or both 1 and 2. Optionally, more than two lights may be operated in a manner similar to that described herein. The specific circuitry for implementing the various embodiments of the controller 30 will be apparent to those skilled in the electrical arts from the description of the invention herein. One example of such circuitry for implementing the controller 30 is shown in the schematic diagram 90 of FIG. 9. Specifically, the schematic diagram of FIG. 9 illustrates that the audio input 22 is electrically connected to the sensitivity adjuster 16. The power indicator 14 is preferably a light emitting diode. The switch 20 preferably permits a user to switch between the modes 20a, 20b and 20c described earlier in relation to FIG. 3. The connectors 18, 34 preferably output the light control signal to the lights. The connector 12 is preferably supplied by a 12-volt DC input and powers the controller 10. In the example of FIG. 9, the switch 32 is not provided because the circuitry has been hard-wired to the “1+2” position 32b. FIG. 3A illustrates the example of FIG. 9, wherein the controller 30 does not include the switch 32. Returning to FIG. 9, the controller 30 optionally includes a timing circuit 92 for processing a signal before it is supplied to the one or more light sources. The timing circuit 92 preferably supports one or more modes of operation to rectify, time lapse magnify, or otherwise modulate a signal in the controller 30. An example of such a timing circuit is the NE555 Precision Timer produced by Texas Instruments. The controller 30 preferably includes transformers 94 connected to the connectors 18, 34. The transformers 94 may translate a DC input preferably received from connector 12 into an AC signal that is preferably supplied to the light source by the connector 18. Preferably, a transformer 94 is provided for each light source that will be controlled by the controller 30. The transformers 94 are preferably included as part of a one-piece controller.

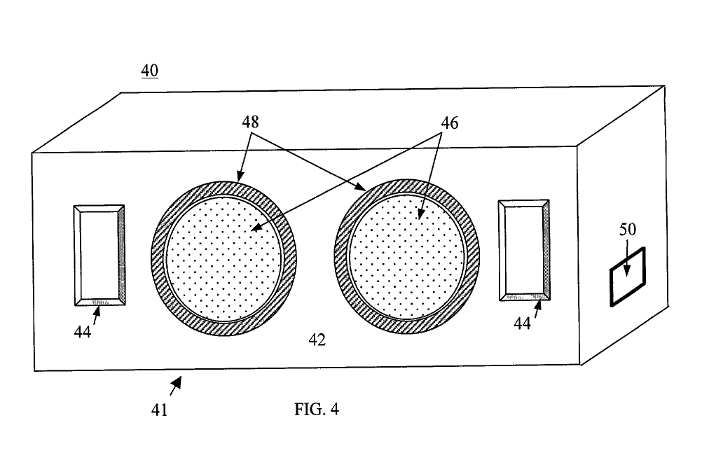

FIG. 4 illustrates a front perspective view of a speaker and light system 40 mounted in a cabinet 41 with lights 48 that may be operated by a controller according to the embodiment of FIG. 1 or the embodiment of FIG. 3. The cabinet 41 of the speaker and light system 40 includes a front 42, tweeters 44, bass speakers (not shown), a grill cover 46, the lights 48, and an optional speaker 50.

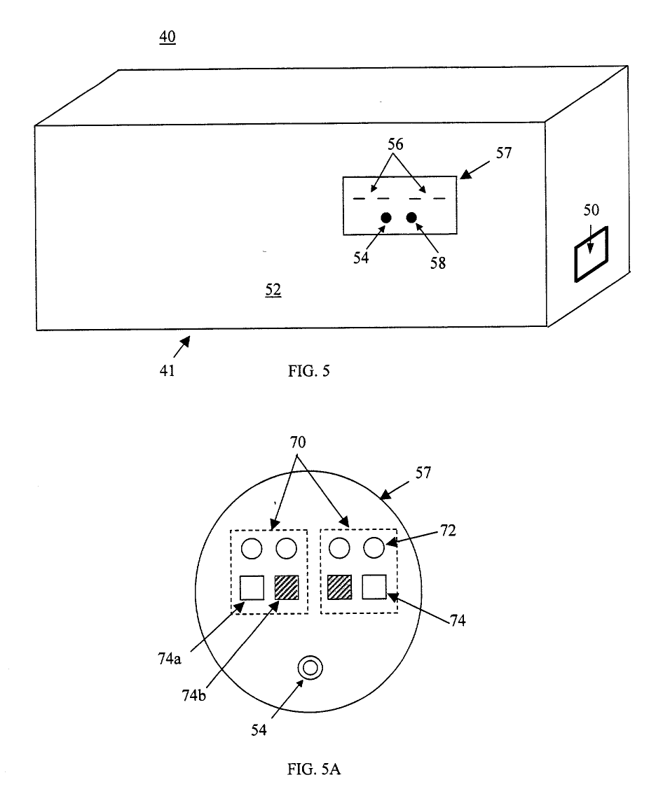

The front 42 of the cabinet 41 may house the tweeters 44, and may house bass speakers behind the grill covers 46. The optional speaker 50, such as a subwoofer, is preferably mounted on a side of the cabinet 41. The lights 48 preferably surround the grills 46. The lights 48, which are preferably circular neon lights, are desirably connected to the controller 30 through the back of the cabinet 41, as is shown in FIG. 5, such that they illuminate according to control options desired by the user. The cabinet 41 may be formed of wood, plastic and/or metal or other materials, and may be covered by a carpet or cloth having a desirable texture and color.

FIG. 5 illustrates a rear perspective view of the speaker and light system 40. A back 52 of the cabinet 41 includes connections 56 and an input 54 for the speakers and the lights 48, respectively. The connections 56 and the input 54 are preferably provided in a terminal block 57. The connections 56 may receive speaker wire, for example, for the sets of speakers contained within the cabinet 41. The input 54 is operable to receive one or both of connectors 18 and 34 (FIG. 3), which preferably control the operation of the lights 48. Preferably, the input 54 is a jack or a plug. More preferably, the input 54 is a jack or a plug such as is used in a DC power supply for a laptop computer, cellular telephone or other commonly used electronic device. The connections 56 may comprise color-coded terminal pairs. Preferably, one terminal of each pair is red and the other terminal of each pair is black. Such color-coding allows for easy wiring by a user. Each terminal is preferably a pushbutton-type terminal.

Advantageously, the input 54 is located on the same region of the cabinet 41 as the connections 56. More particularly, the input 54 and the connections 56 are preferably located on the terminal block 57. The terminal block 57 is preferably formed as a one-piece plastic block. The terminal block 57 may be circular, rectangular, polygonal or any other desired shape. The terminal block 57 may be added to the cabinet 41 as part of a normal manufacturing process or may be added after manufacturing by, for example, an audiophile who desires to supplement a stereo system by adding a visual aspect to aural perception.

The terminal block 57 advantageously provides a single, integral unit for the input 54 and the connections 56 to the speaker and light system 40, as shown in FIG. 5A. More particularly, FIG. 5A illustrates the terminal block 57 comprising the input 54 and the connections 56. This figure shows the connections 56 as two sets of terminal pairs 70. Each terminal of a terminal pair 70 preferably comprises a receptacle 72 and a pushbutton 74. Preferably, one pushbutton 74a of a terminal pair 70 is one color (e.g., red) and the other pushbutton 74b of a terminal pair 70 is another color (e.g., black). The receptacle 72 preferably receives a speaker wire. By way of example only, 22-gauge speaker wire may be inserted into the receptacle 72. The pushbutton 74 is preferably employed to allow, for example, a user to insert the speaker wire and/or to prevent the speaker wire from accidentally dislodging from the receptacle 72. Thus, a user is able to quickly and conveniently set up and maintain the speaker and light system 40. Returning to FIG. 5, the back 52 may optionally include a power input 58, which may also be integrated on the terminal block 57. The power input 58 may be used to power the speakers and/or additional circuitry of the speaker and light system 40 housed within the cabinet 41.

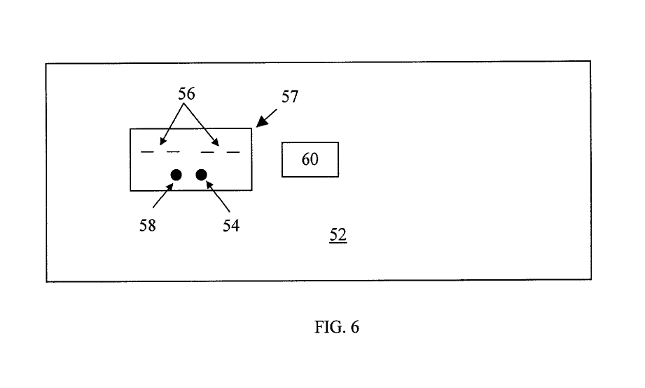

FIG. 6 illustrates an interior view of the back 52 for a preferred embodiment of the invention. Specifically, FIG. 6 shows the input 54, connections 56, power input 58, and, preferably, additional circuitry 60. For clarity, the wiring between these elements and the speakers and lights is not shown. The additional circuitry 60 may be, for example, a portion of the circuitry of the controller 30 or 10. In one embodiment, the additional circuitry 60 comprises one or more transformers that may be used to improve the light intensity of the lights 48. In another embodiment, the additional circuitry 60 comprises a DC to AC converter. The DC to AC converter preferably converts a DC signal supplied to the input 54 into an AC signal, as may be required when the lights 48 employ neon technology. In yet another embodiment, the additional circuitry 60 comprises a timing circuit alone or in combination with a transformer or DC to AC converter. The timing circuit, which may be timing circuit 82 (FIG. 8) or the timing circuit 92 (FIG. 9), preferably offers different modes of operation to rectify, time lapse magnify, or otherwise modulate a received audible signal. An example of such a timing circuit is the NE555 Precision Timer produced by Texas Instruments. A benefit of placing the additional circuitry 60 inside the cabinet 41 of the speaker and light system 40 is that it reduces the size of the controller 30 or 10.

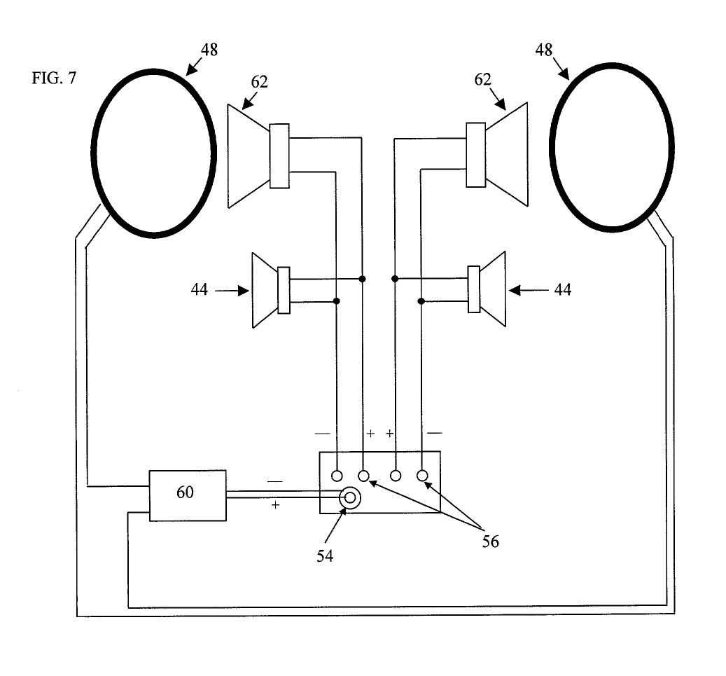

FIG. 7 is a schematic diagram illustrating of one way of wiring the lights 48, speakers and additional circuitry 60 of the cabinet 41 of FIG. 4. The tweeters 44 and a pair of bass speakers 62 may be driven by the connections 56. The bass speakers 62 may optionally be powered by the power input 58 according to FIG. 6. The bass speakers 62 are preferably eight inch round woofers. Preferably, the bass speakers 62 are connected to the connections 56 by means of quick connectors or quickly releasable connection means to allow for easy installation or removal of the bass speakers 62 within the cabinet 41.

The additional circuitry 60 may receive a DC signal from the input 54 and provide an AC signal to each of the lights 48. The additional circuitry 60 may be mounted to the bottom, sides or top of the interior of the cabinet 41. Preferably, the lights 48 are eight inch round neon lights that are disposed about the bass speakers 62. The lights 48 are preferably wired in series.

The light control device of the present invention may operate in a number of modes. For example, an audible signal may be received from an audio or sound source. A sensitivity control switch, or sensitivity adjuster preferably adjusts such that the brightness of a light source varies between a substantially maximum brightness and a substantially minimum brightness. For example, the sensitivity control switch may include a potentiometer or transformer, whereby a user can adjust the potentiometer or transformer to modify a light control signal, thereby increasing or decreasing the brightness of the light. This adjustment creates a sensitivity-adjusted signal. The sensitivity-adjusted signal may be demodulated and rectified as part of the process of creating the light control signal. Then another part of the process of creating the light control signal may include time-lapse magnifying the sensitivity-adjusted signal, and may also include inverse rectifying the sensitivity-adjusted signal, forming the resultant light control signal. The light control signal may then be supplied to the light source, thereby effectuating the illumination of the light source. The light control signal may be supplied to the light source with direct wiring or through wireless means, such as a radio frequency or infrared signal.

Preferably, one method of controlling a light source includes receiving an audible signal, operating on the audible signal, and outputting a light control signal based upon the operations performed on the audible signal. For example, a sensitivity-adjusted signal is preferably created by adjusting a transformer, potentiometer or other variable component. The sensitivity-adjusted signal preferably adjusts such that the brightness of the light source varies between a substantially minimum and a substantially maximum brightness. In conjunction or separate from the sensitivity adjustment, the method of operation may include choosing an operational mode. One operational mode may include forming the light control signal such that a light source is preferably always on. A second operational mode may include forming the light control signal such that the light source is preferably always off. A third operational mode may include forming the light control signal such that the light source preferably turns on and off in relation to the audible signal.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A light control device for controlling a visual display of a light source comprising:
an audio input for receiving an audible signal produced remotely and sending an output signal based upon the audible signal; and
a light controller unit for receiving the output signal and sending a light control signal to adjustably control the light source.

2. The light control device of claim 1, whereby the light control signal is operable to turn the light source on and off.

3. The light control device of claim 1, whereby the light control signal is formed automatically based upon music.

4. The light control device of claim 1, whereby the light control signal is formed in response to user control.

5. The light control device of claim 1, further including a sensitivity adjuster operable to receive the output signal and form an adjusted signal for output to the light controller unit.

6. The light control device of claim 5, wherein the adjusted signal is operable to modify the light control signal such that the light source is variable between a minimum and a maximum brightness.

7. The light control device of claim 1 wherein the light controller unit includes selectable operational modes, including a first mode in which the light control signal is operable to turn the light source on continuously, a second mode in which the light control signal is operable to turn the light source off, and a third mode in which the light control signal is operable to turn the light source on and off in response to the audible signal.

8. The light control device of claim 1, further including a transformer operable to receive the light control signal and transmit a transformed light control signal to the light source.

9. A light control device comprising:
an audio input for receiving an audible signal and sending an output signal based on the audible signal;
a light controller unit for receiving the output signal and sending a light control signal to adjustably control a light source; and
a sensitivity adjuster operable to adjust the light control signal whereby the light source is variable between a minimum and a maximum brightness.

10. The light control device of claim 9, wherein the sensitivity adjuster is adjustable between a minimum adjustment and a maximum adjustment, the minimum adjustment corresponding to the minimum brightness of the light source and the maximum adjustment corresponding to the maximum brightness of the light source.

11. The light control device of claim 9, wherein the sensitivity adjuster comprises an adjustable transformer.

12. The light control device of claim 9, wherein the sensitivity adjuster comprises a potentiometer.

13. The light control device of claim 9, further including a transformer operable to receive the light control signal and transmit a transformed light control signal to the light source.

14. An apparatus, comprising:
an audio input for receiving an audible signal produced remotely and sending an output signal based on the audible signal;
a sensitivity adjuster operable to receive the output signal and form an adjusted signal;
a light controller unit for receiving the adjusted signal and forming a light control signal to adjustably control a light source; and
a speaker unit including a housing and a speaker disposed in the housing, whereby the light source is disposed adjacent to the housing.

15. The apparatus of claim 14, wherein the housing includes a speaker input to drive the speaker and a light control input in proximity to the speaker input, whereby the light control input is connected to the light source and is operable to receive the light control signal and pass the light control signal to the light source.

16. The apparatus of claim 14 wherein the light source is a neon light.

17. The apparatus of claim 14, wherein the audible signal is produced remotely by a speaker.

18. A method of controlling at least one light source, comprising:
receiving an audible signal produced remotely from an audio speaker;
forming a sensitivity-adjusted signal based upon the audible signal, the sensitivity-adjusted signal being operable to adjust a brightness of the at least one light source; and
outputting a light control signal in relation to the sensitivity-adjusted signal, whereby the at least one light source is controlled in response to the light control signal.

19. The method of claim 18 wherein outputting the light control signal includes selecting a mode of operation from a first mode in which the light control signal is operable to turn the light source on continuously, a second mode in which the light control signal is operable to turn the light source off, and a third mode in which the light control signal is operable to turn the light source on and off in response to the audible signal.

20. The method of claim 18, further including adjusting the sensitivity-adjusted signal between a minimum adjustment corresponding to a minimum brightness of the light source and a maximum adjustment corresponding to a maximum brightness of the light source.

21. The method of claim 18 wherein the sensitivity-adjusted signal is formed in response to user control.

22. A light control device comprising:
an audio input for receiving an audible signal and producing an output signal based on the audible signal;
a light controller unit for receiving the output signal and forming a light control signal to adjustably control a light source, the light controller unit having selectable operational modes including a first mode in which the light control signal is operable to turn the light source on continuously, a second mode in which the light control signal is operable to turn the light source off, and a third mode in which the light control signal is operable to turn the light source on and off in response to the audible signal;
a sensitivity adjuster operable to adjust the light source between a minimum and a maximum brightness;
a power indicator for indicating whether the light control device is on; and
a connector operable to supply power to the light source.

23. The light control device of claim 22, wherein the light controller unit includes a transformer operable to modify the light control signal before the light control signal is supplied to the light source.

24. The light control device of claim 22, wherein the light controller unit includes a DC to AC converter operable to convert a DC light control signal into an AC light control signal, the AC light control signal being supplied to the light source.

25. A speaker housing comprising:
a cabinet;
a connection disposed on the cabinet, the connection being operable to receive an audible signal and provide the audible signal to a speaker; and
an input adjacent to the connection, the input being operable to receive a light control signal and provide the light control signal to a light source.

26. The speaker housing of claim 25, wherein the input and the connection are disposed on a back face of the cabinet.

27. The speaker housing of claim 25, wherein the light control signal is received from a light control device.

28. The speaker housing of claim 25, further comprising a DC to AC converter disposed within the cabinet, the DC to AC converter being operable to convert a DC light control signal into an AC light control signal and supply the AC light control signal to the light source.

29. The speaker housing of claim 25, further comprising a power input disposed adjacent to the input and the connection, the power input being operable to power the speaker.

30. The speaker housing of claim 25, wherein the connection and the input are disposed on a terminal block.

31. A speaker housing comprising:
a cabinet;
a speaker disposed in the cabinet;
a light source disposed adjacent to the speaker;
a connection operable to receive an audible signal and provide the audible signal to the speaker, the connection being disposed in the cabinet remote from the speaker; and
an input adjacent to the connection, the input being operable to receive a light control signal and provide the light control signal to the light source.

32. A terminal block comprising:
a base unit;
a connection disposed on the base unit, the connection being operable to receive an audible signal and provide the audible signal to a speaker; and
an input being operable to receive a light control signal and provide the light control signal to a light source.

33. The terminal block of claim 32, wherein the base unit has a rectangular shape.

34. The terminal block of claim 32, wherein the base unit has a circular shape.

35. The terminal block of claim 32, wherein the connection further includes a terminal having a receptacle and a pushbutton, whereby the receptacle is operable to receive a speaker wire and the pushbutton is operable to permit insertion and prevent accidental removal of the speaker wire from the receptacle.
